(19) United States
(12) Patent Application Publication
(10) Pub. No.: US 2009/0254457 A1
(43) Pub. Date: Oct. 8, 2009

(54) Video based product setup instructions via web services applications

(75) Inventor: Kim Tadlock Folsom, San Diego, CA (US)

Correspondence Address: Law Office of Scott C Harris Inc, PO Box 1389, Rancho Santa Fe, CA, 92067, US

(73) Assignee: VuQuest Inc, San Diego, CA (US)

(21) Appl. No.: 12/416,845

(22) Filed: Apr. 1, 2009

Related U.S. Application Data
(60) Provisional application No. 61/072,803, filed on Apr. 3, 2008.

(51) Int. Cl. G06Q 30/00

(52) U.S. Cl. 705/27

(57) ABSTRACT

A system that provides video based assembly or setup instructions for a product. A link to the instructions from another website that allows purchasing the products, can be made

This application claims priority from provisional application No. 61/072,803, filed Apr. 3, 2008, the entire contents of which are herewith incorporated by reference.

### BACKGROUND

Purchased products are often purchased in a disassembled state, and sent to a user in that disassembled state. The disassembled product is easier for mailing, and is more protected against damage. The user needs to assemble or set up the products in order to use them properly.

The products are shipped and/or sold disassembled. However, once the products is delivered to the, the user must assemble or set them up, usually from written instructions.

It is often difficult to follow the instructions, especially for those who are not mechanically inclined. This leads some users to refuse to buy products that are not already fully assembled. Other users may damage the product during assembly, and consequently return it. Still other users may return the unit simply because they think it is too difficult to assemble.

Some manufacturers offer products that are fully assembled; but those products are often much more expensive and more difficult or costly to ship.

### SUMMARY

The present application describes using a computer system to provide instructions for assembly of a purchased item over the internet, where the instructions include a first playback segment, a second playback segment, and a third playback segment, which collectively provide assembly instructions for the purchased item, using the computer for playing each of the playback segments, to collectively display assembly or setup instructions for the item.

The computer can also be used to purchase the item over the internet.

### BRIEF DESCRIPTION OF THE DRAWINGS

### In the Drawings:

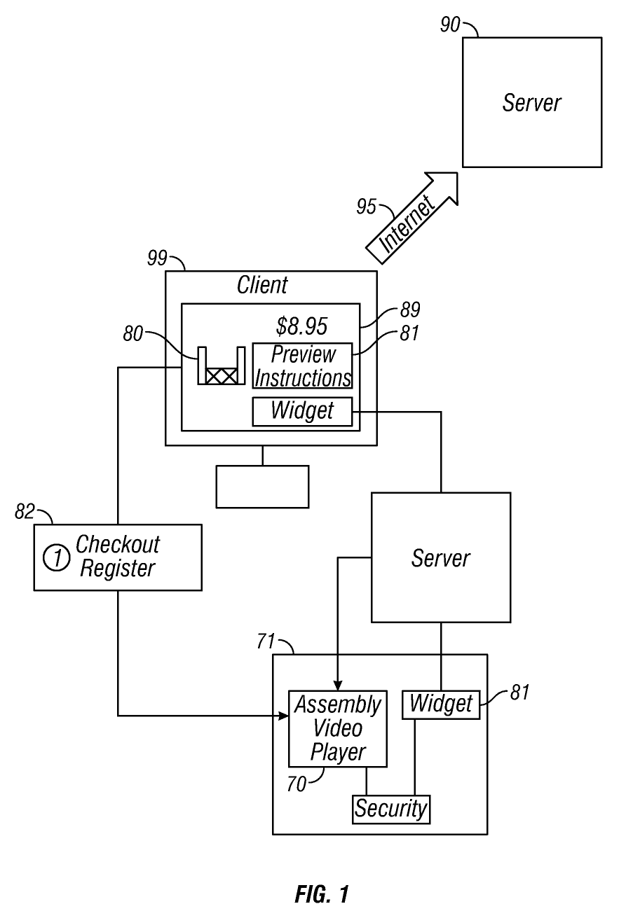

FIG. 1 shows a diagram of use of different clients to purchase and assemble an item;

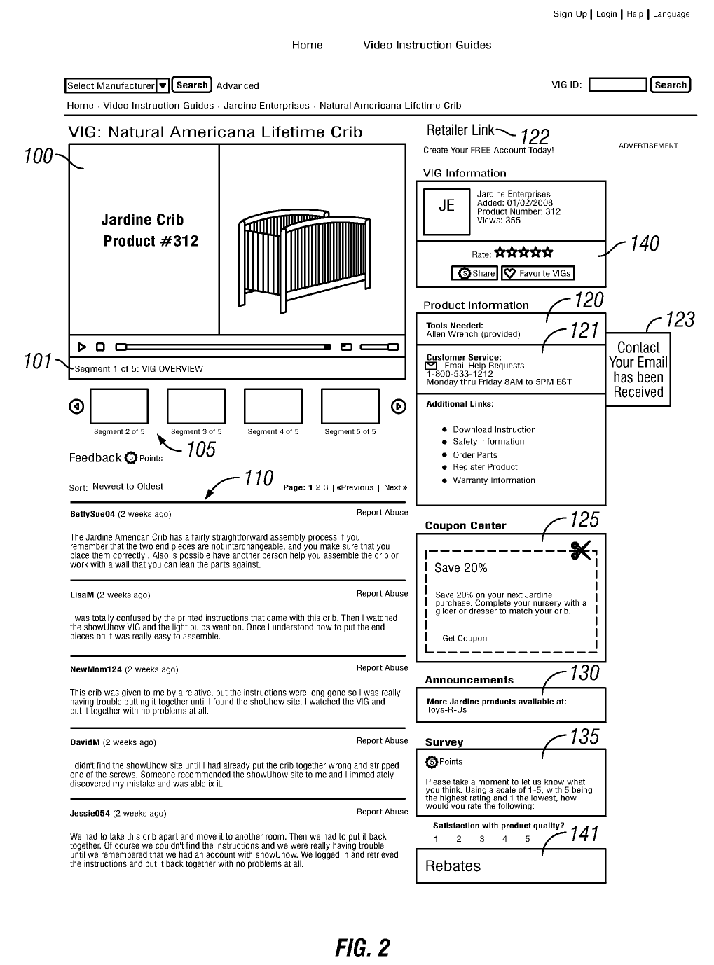

FIG. 2 shows a main page of assembly or setup instructions;

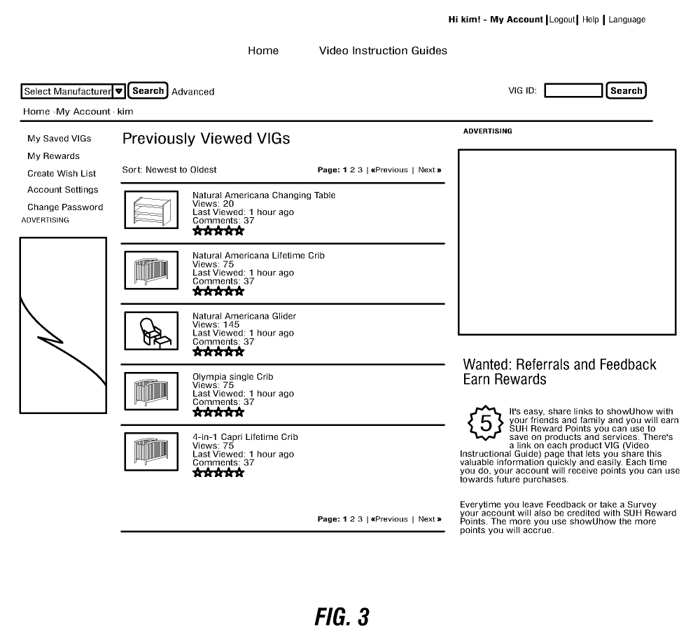

FIG. 3 shows a personal page with saved assembly instructions;

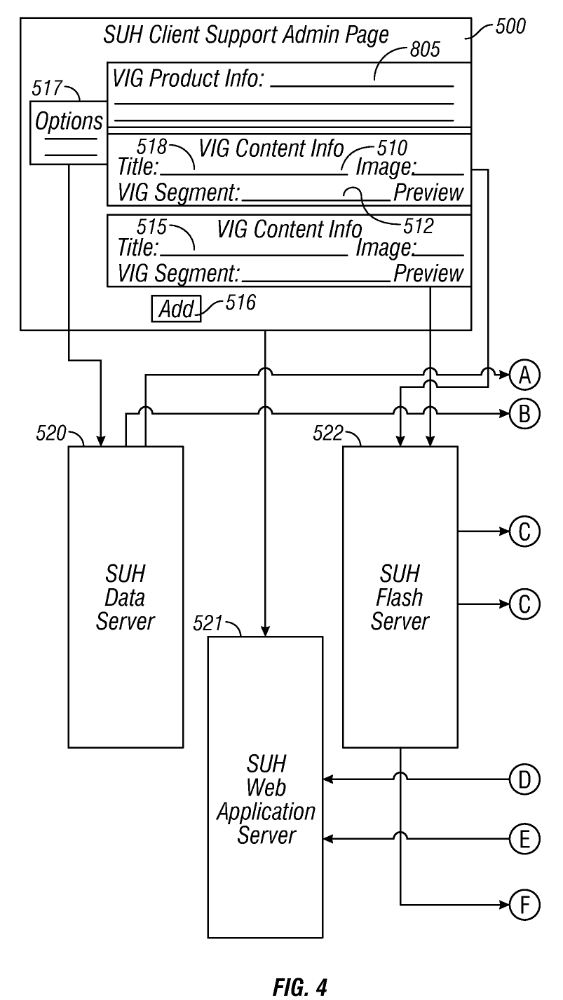

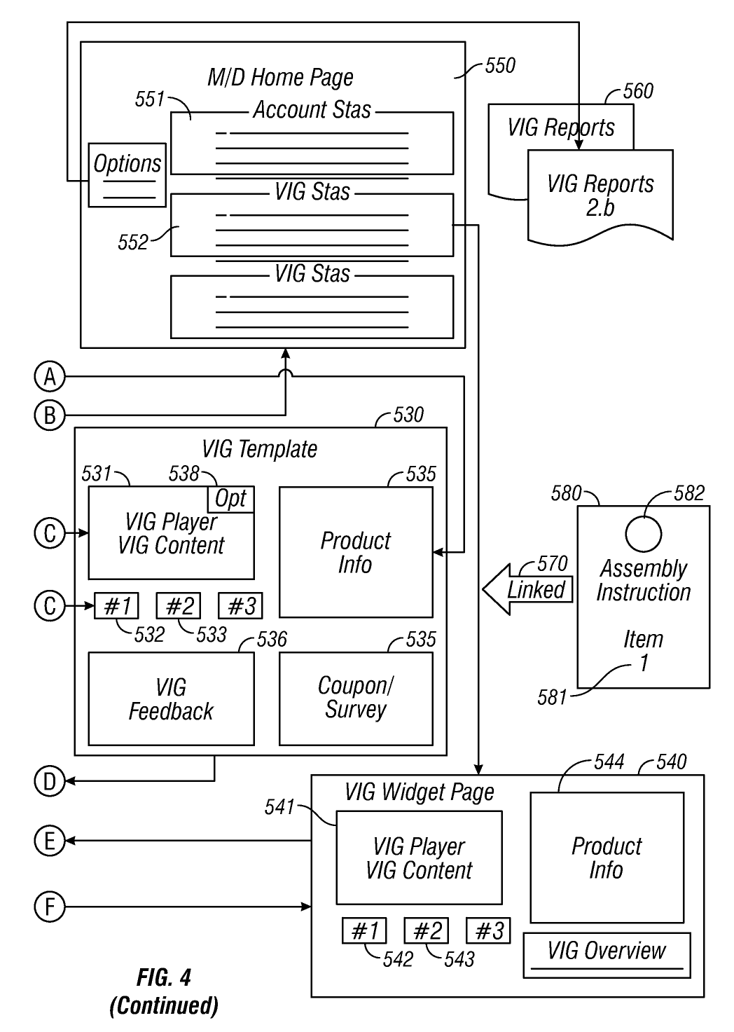

FIG. 4 shows a block diagram of the server and connections;

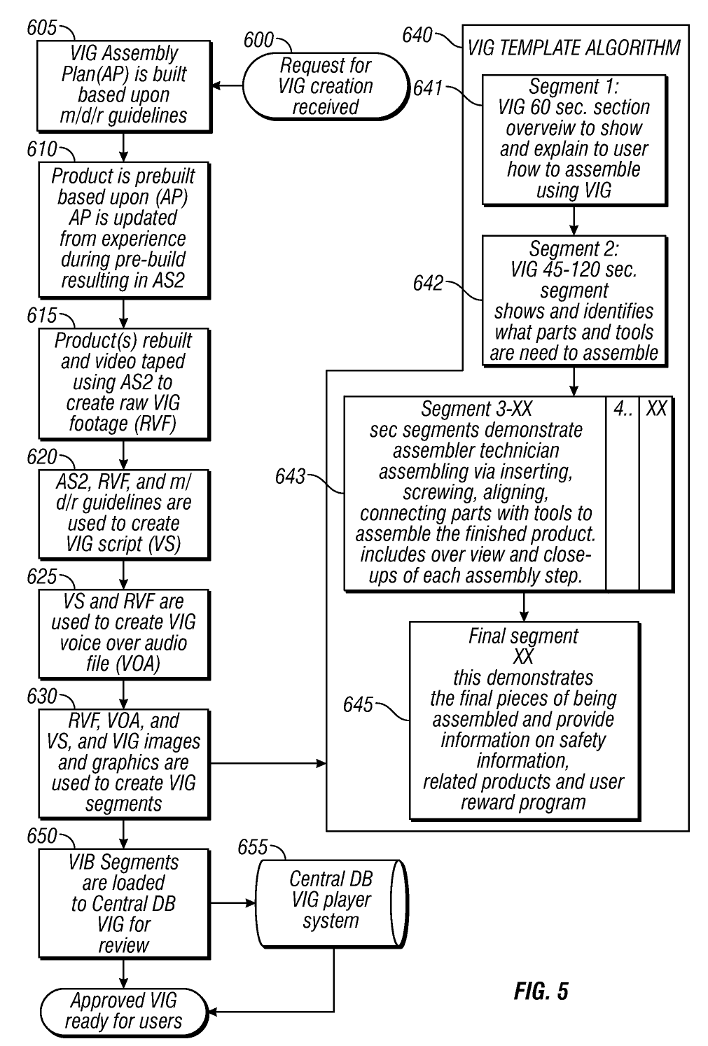

FIG. 5 shows a template creation process;

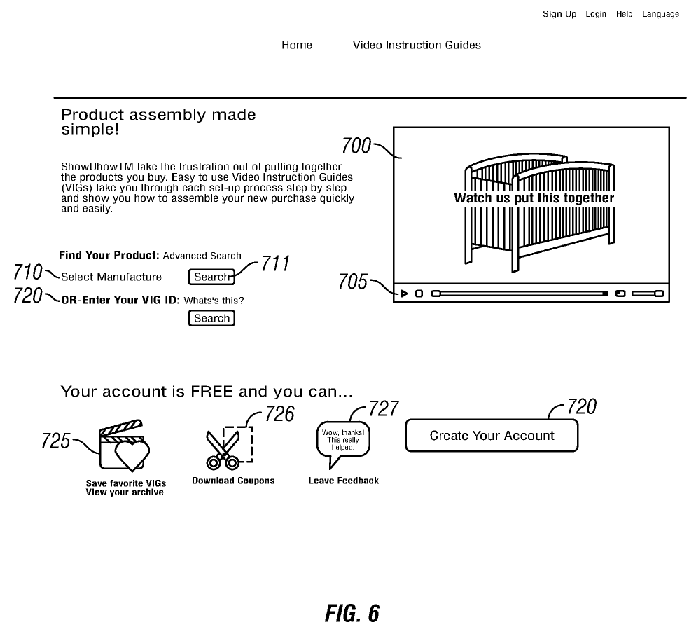

FIG. 6 shows an initial screen from the website; and

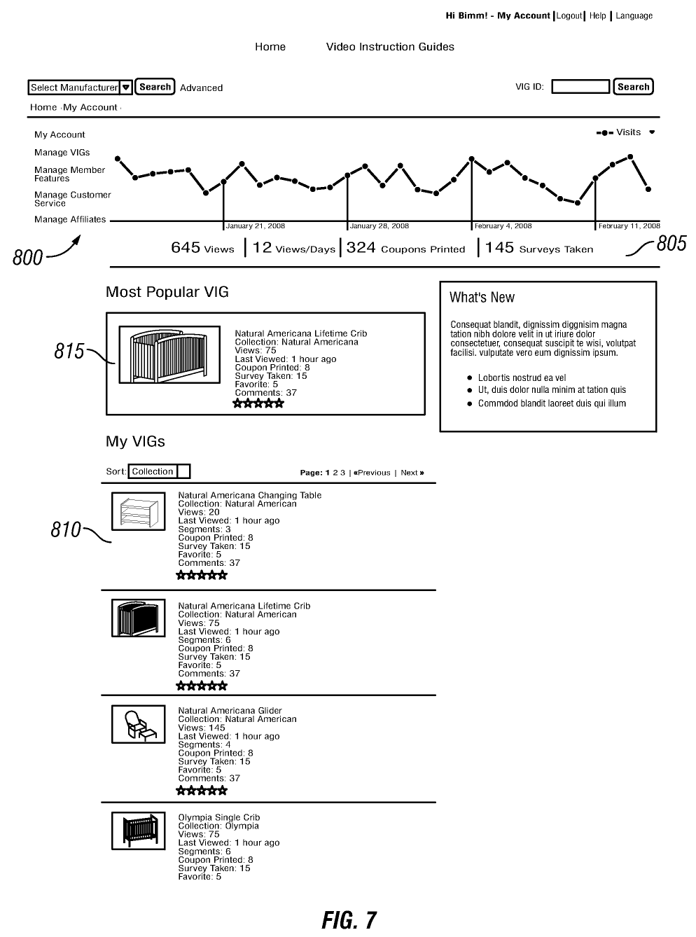

FIG. 7 shows an account management screen.

### DETAILED DESCRIPTION

An embodiment as described herein provides video assembly instructions for products on an internet web page that is also linked to other product information.

The guides are referred to herein as video instruction guides or VIGs. Each guide provides video based product assembly instructions for a product. The guides are shown on an internet web page. Each guide provides a step by step process for total assembly or setup of the product as defined in the user instruction manual, and other guides can be selected, allowing the user to collectively view all the guides. The web page also provides other kinds of product support information. For example, in addition to providing the assembly based instructions, the system also provides related customer and sales support over the same web based application.

In an embodiment, the video instruction guide provides indexed, separated, fixed time instructions. For example, these may include step-by-step demonstrations of the product being assembled. The first video instruction guide segment represents a “60 second” overview of the product assembly. Starting from the completed product, then its disassembled state in the box, the parts and tools needed, then the stages to setup the product. The remaining segments guide the user step-by-step through the process of identifying the tools needed, parts included in the box, the each step of the setup process to compliment the assembly guide. The user can play the video instruction segments one by one from the initial unpacking and parts list, to its final stage when it is assembled and ready to use.

The indexed instructions may include, for example, a parts list, as well as a list of tools that may be necessary to assemble and use and set up the product. Another feature of the video instruction guide is its ability to interface with product support. The product support may include all of product support, customer support and sales support. This can be done through a single communication interface using the same interface as the Web services applications. For example, the same client that shows how to assemble the products, and also includes the ability to interactively register the product, obtain warranty information, safety information, as well as order missing or replacement parts, and obtain an electronic version of the different user guides.

The operation is carried out by accessing the webpage on a client (product manufacturers computer, retailers computer, or consumer's) computer 99, over the internet 95 or on a personal data assistant. The accessing is shown being carried out from a client computer. All of the operations described herein can be carried out on a client computer such as 71 or 91 via accessing a server.

The basic instruction page is shown as FIG. 2. A user has selected a product shown as 100, which brings up the information page about the product 100, its assembly, and other information about the product.

FIG. 2 shows the player 103 playing segment number 101. The user can also select other segments from the segment bar 105. Each segment represents a specific interval of installation instructions, e.g., 40-120 seconds of information. The segment bar 105 shows for example the other segments that can be watched—segment number 2, segment 3, etc. Each segment can be a fixed amount of information or can generally be a divided up portion of assembly instructions that represent a certain step of the install.

The user can also view feedback at 110 which provides feedback about how easy or difficult it was to assemble the item, including comments on the assembly and the ease or difficulty of the assembly. In one embodiment, as described herein, that feedback is used by the video developers to create version 2 of the information guide.

A product information section provides additional links and more information about the product beyond just the assembly instructions. Summary information about the item is provided in the summary box 120. This includes the tools that are needed for assembly, customer service phone numbers, as well as additional links allowing the user to obtain safety information; order parts; register the product, and register and/or redeem warranty information.

A coupon center 125 provides targeted coupons to a user. These coupons can provide discounts off a user's next purchase of goods that are similar to the good being assembled. The coupon for a discount can be towards repeat purchases, additional purchases, or accessory purchases.

An announcement link 130 may provide targeted advertising or product updates or recall information, e.g., indicating where user might be able to buy another one of these items.

The user can take a survey at 135 to rate the assembly information information, e.g., as to how easy or hard it was to use. The user can also rate the product itself at 140.

FIG. 3 shows a list of previously viewed video information guides for a user. This allows users to add information guides to their personal space. The user's personal space, therefore, includes all of the information guides for all of the products that the user owns. A user can easily find all their previous instructional guides to the extent that they might want to use them.

As one embodiment, the main page of FIG. 2 allows a user to submit additional requests for additional support, e.g., via the link to manufacturer customer support, or via a retailer link 122.

Clicking on the links, e.g., 121 or 122, allows sending an email to customer support or the retailer, via a pop up window 123. The pop up window 123 allows sending an email for a new support request. It also provides status of any previous support request(s) that have been previously sent.

Other sales functions can also be obtained from the video information guide page. The sales functions can include a rebate function 141, which allows registering to receive, for example, a manufacturer's rebate.

The information guide can also include a link to a knowledge base and user community. The user community allows users to review and provide information about their experience with the product.

The product assembly instructions can be shared with friends by email. In addition to ranking the product, the page allows the end-user to share a review of the product assembly information. For example, you can tell your friend that the product was good or bad, easy or hard to put together, etc.

In one embodiment, the video information page may be supported by a membership rewards system that allows an end-user to earn points by using certain features from the system. Product, customer and sales data can be offered on the page. As the user uses these features, the user is awarded points that are added to a reward system profile. Users have the ability to earn gift certificates and coupons based on accumulated points levels.

Another embodiment operates according to a presale widget, which operates on the client 99. The client 99 displays a webpage 89 which shows products, such as 80. The webpage 89 has information about the products, such as price and ordering information, and a picture and specifications. The webpage 89 shows the presale widget 81 as a compressed version of the video information guide. This widget 81 allows the end-user to view segments of the video information guide as part of the purchase decision from an online retail catalog page. For example, this can be a link to the assembly website, or can be a summary version of the complete assembly guide.

The user can select the link 81 to obtain an overview of the process of assembling, and showing benefits of assembling the product using the video information guide. In this way, part of the purchasing experience includes the video information guide illustrating the instructions for assembly.

Hence, one aspect includes a separated set of videos which define the assembly of the product which is linked to the purchase page.

The videos can be freely available, or can be security protected to determine a user's level of security is determined to determine if they should have appropriate access to the video instructions that they have selected. A user who has purchased an item at 82 is allowed to register that item, which can provide the needed security authorization. The system may verify the security before providing them with those instructions. A user who has appropriate access receives delivery of the instruction videos. A user who does not have the appropriate access level may receive an error message, or alternatively, may receive only access to the presale widget 81.

The central delivery player system 70 can play on any client, e.g. 71, that includes devices that select an appropriate player skin, size and type of the video instruction guide based on the template for the destination page as shown in FIG. 4. The player process also manages identification (storage), script (process), and transfer (send) of video instruction content to all the players within the pages, product, customer, sale and support system.

FIG. 4 shows a block diagram of the player.

According to the embodiment, coordinators and videographer producers can input video instruction guide information, as well as the links to the information. Page 500 is a support administration page that allows the producer to enter a product name 505, for example product_{—}1. For that product_{—}1, the producer can enter a number of different video information guides such as 510, 515. Each video information guide such as 510 may have a title such as product_{—}1 initial installation guide. It can also include a segment such as 512, which can be a selection of its contents, e.g, for use as part of the presale widget, or to provide to users without proper credentials. An add button 516 can allow providing additional content.

In addition, the producer can set certain options, such as whether the video is public or requires security. For example, some companies or products might make their instructions wholly public, while others require certain logins. All of the information is stored on one of the servers.

The information may be separately stored on a data server 520, a Web application server 521, and an animation server 522, here a flash server. Information which has been stored in this way can be then played by a user while being displayed according to a template. The template page shown as 530 includes a specialized player 531 with which interfaces with the content from the animation server 522. The animation server 522 may provide the content information, such as 510 and 515, as the different animations to be provided. See for example content number 1 shown as item 532 and content number 2 shown as 533.

The data server 520 provides the product information which is displayed as 535. For example, part of the template may include a picture of the product after it has been finally assembled.

The user can also leave feedback shown as 536 including feedback on the product and feedback on the assembly instructions, and that feedback is shown on the main page of FIG. 2. A coupon/survey part 537 may provide coupons and surveys, e.g, based on the product being assembled.

There can also be a widget page 540 which is separate from the template page. The widget page uses player information 541 to provide a number of different elements of content 542, 543 based on the presale widget, and to provide an overview based on the information 544.

Finally, the homepage 550 can assemble the page shown in FIG. 2. The can be the place where the users to enter their information including account information 551, as well as VIG statistics 552.

The producers can upload and release their video information content. Once released, this content can be accessed from the homepage 550 according to the format set by the template page 530. During all operations, statistics or related to number of views as well as access are written to the data server 520. The data server collects information for reports shown as 560 which show the number of times that items have been viewed, how many users clicked on the alternative content such as coupons or surveys, etc. The template page 530 accesses a central player and the index images, as well as the animations 522 stored on the animation server 522 in order to play any of the segment files as necessary.

The player also includes certain options shown generically as 538. The options can be used to set the language of content, and the size of the video or other information.

As shown by 570, the entire process can be linked to by a user who is on the retailer's page 580 viewing item 581. One of the links on this page is to assembly instructions 582.

The clip itself can be formed using the techniques described with reference to FIG. 5, which shows a flowchart of operation that can be carried out on a computer that is operating a web browsing client.

Responsive to a request for creation at 600, an assembly plan is built based on guidelines e.g. the manufacturer's guidelines. The assembly plan is first made at 610, and may be released as a version 1.

Version 2 of the assembly may be created and/or revised based on user feedback. At 615, the product is rebuilt and videotaped using the assembly to create the raw footage, which may include video information and animation information. A script is created at 620. At 625, this information is used to create voice over video files. Segments are created at 630. 640 shows what these segments can include. For example, the first segment 641 can include an overview to explain how to assemble using the video information guides. The second segment, which is preferably between 45 and 120 seconds, shows and identifies the parts and tools needed to assemble at 642. Beginning at segment three, 643, and going up to segment x, where there is no maximum number of segments that can be provided, the technicians demonstrate how to assemble a device, showing the different features including alignment, fastener attachments, connecting with tools, etc. to create the finished product. This includes an overview and a close-up of each assembly step as necessary. The final segment x at 645 shows the final pieces being assembled. This also provide safety information, explanations about related projects, and the user reward program.

Once all the segments have been created in this way, the segments are uploaded at 650 to the central database for review. They are stored in a central database player at 655.

FIG. 6 illustrates an actual screenshot of the introduction page, which allows a user to obtain video information about a product. The actual page includes a video section 700, with play control 705. A user can select their manufacturer at 710 and execute a search for the desired item. Alternatively, a user can create an account shown by 720. Thereafter, called up data gets associated with a user account. A user can later enter their account ID at 721 to call up stored assembly information. Registered account holders can also save favorites at 725, download coupons at 726, and leave feedback at 727.

FIG. 7 illustrates a personalized page on the website, where the user has options provided to them at 800 including managing their account, video information guide, member features, customer service, or affiliates. Once entering the page, it provides certain statistics about what the user has done at 805, how many views have occurred, including how many views per day, coupons, surveys, and the like. It also shows the collection of all the downloaded information guides at 810, and shows the most popular one at 815. The most popular one may be the one that is most often viewed, for example, in the last seven or 14 days.

Advantages of this system may include the following. By providing more detailed information and actual demonstrations of the assembly and setup then might be possible in text-only of grapicanimated environment, it becomes easier for the user to assemble, setup of the product and quicker use. This avoids returns, and leads to better customer satisfaction with the product. It also avoids damage to the products, which can also lead to returns or warranty claims. This reduces the In addition, users who bought a product automatically become a targeted marketplace. Advertisements on the product page are more likely to meet a receptive market for those advertisements, as the are mostly previous customers. This provides a win-win situation: the consumers get better instructions but also get coupons and other information. The consumers can also download the owner's manuals. Manufacturers can announce new products and commucate product updates or recalls. Retailers receive point-of-sale marketing materials, and receive better sales support since a large part of product satisfaction is always caused by ease of assembly or setup.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other formats and templates can be used and other forms of internet pages can be used. Also, the inventors intend that only those claims which use the-words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method comprising:
using a computer system to provide instructions for assembly of a purchased item over the internet,
said instructions including a first playback segment, a second playback segment, and a third playback segment, which collectively provide assembly instructions for said purchased item,
using said computer for playing each of said playback segments, to collectively display assembly or setup instructions for said item.

2. A method as in claim 1, further comprising using said computer to purchase said item over the internet.

3. A method as in claim 2, further comprising viewing said product for sale on the internet prior to purchasing said product, and also viewing information about said instructions on the internet prior to purchasing said product.

4. A method as in claim 3, wherein said information about said instructions includes a shortened version of said instructions which has some, but not all, of the complete assembly instructions for the item.

5. A method as in claim 3, wherein each said playback segment is a specified length of time.

6. A method as in claim 1, further comprising restricting playing of said playback segments to only authorized users.

7. A method as in claim 6, further comprising allowing all users to view a shortened version of said instructions which has some, but not all, of the complete assembly instructions for the item.

8. A method as in claim 1, further comprising A a shortened version of said instructions which has some, but not all, of the complete assembly instructions for the item.

9. A method as in claim 1, further comprising providing instructions which allow a user to rate the product itself and allowing the user to rate separately the product installation.

10. A method as in claim 1, wherein each of said playback segments includes video.

11. A method as in claim 1, wherein each of said playback segments includes audio and video.

12. A computer system comprising:
a computer, connected to the internet;
said computer programmed to display animated instructions for assembly of a purchased item based on information received over the internet,
said instructions including a first playback segment, a second playback segment which is separate from said first playback segment, and a third playback segment, which collectively provide assembly instructions for said purchased item,
said computer displaying controls for playing each of said playback segments, and for playing each item responsive to an actuation of a control.

13. A system as in claim 12, wherein said computer is used to purchase said item over the internet.
